(19) United States
(12) Patent Application Publication
(10) Pub. No.: US 2010/0061790 A1
(43) Pub. Date: Mar. 11, 2010

(54) LABEL ROLL HOLDER RETURNING MECHANISM FOR BARCODE PRINTER

(75) Inventors: CHENG-HAO YU, YILAN COUNTY (TW); CHAO-CHENG HSU, YILAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: TSC AUTO ID TECHNOLOGY CO., LTD., I-LAN HSIEN (TW)

(21) Appl. No.: 12/554,211

(22) Filed: Sep. 4, 2009

(30) Foreign Application Priority Data
Sep. 8, 2008 (TW) 097216208

(51) Int. Cl. B41J 15/00

(52) U.S. Cl. 400/613

(57) ABSTRACT

A label roll holder returning mechanism is provided for a barcode printer and includes at least one restoration roller, a coiled resilient element, at least two movable rails, and at least two label roll holding elements. The restoration roller is rotatably mounted to a bottom of the barcode printer and has a top portion forming a positive-movement engagement section. The coiled resilient element is received inside the restoration roller to provide a restoration force to the rotation of the restoration roller. The movable rails are set to the bottom of the barcode printer in a substantially parallel manner. Each movable rail has a surface forming at least one counterpart positive-movement engagement section engaging the positive-movement engagement section of the restoration roller. The label roll holding elements are arranged at a top of the barcode printer and are coupled to the movable rails respectively, whereby the label roll holding elements offer the function of outward separating from each other for removing and installing a roll of label and inward approaching each other to clamp and hold the label roll by means of the engagement between the restoration roller and the movable rails and the restoration force thereof. As such, a label roll holder returning mechanism featuring balanced force restoration is provided.

### BACKGROUND OF THE INVENTION

1. Field of the Invention

The present invention relates to a label roll holder returning mechanism for a barcode printer, and in particular to a restoration roller that features balanced force restoration and applicable to a barcode printer to provide an automatic returning mechanism for label roll holders installing or clamping a roll of label.

2. The Related Arts

In a conventional barcode printer, a roll of label to be printed is installed inside the barcode printer to realize label printing by a printing mechanism. The label roll holding mechanism of the conventional barcode printer only works for label rolls of fixed diameter and fixed length and is not applicable to the installation or clamping of label rolls of other sizes. This imposes undesired limitation to the development of the barcode printer industry. Further, for label rolls that cannot be securely clamped inside the barcode printer, the quality of printing is adversely affected.

To overcome such problems of fixing label rolls inside the conventional barcode printer, a solution is proposed by U.S. Pat. No. 5,813,343, which provides a “printing media roll mounting and positioning mechanism”, teaching using engagement between pinion and racks, together with a spring coupled between each rack and an enclosure of the barcode printer to provide a restoration force for the individual roll mounting mechanism, to install or release the printing medial roll.

The solution provided by the above mentioned U.S. Pat. No. 5,813,343 that the media roll mounting mechanism uses the restoration spring force to realize clamping and releasing of the media roll has a major disadvantage that the springs that are coupled between the racks and the printer enclosure are exposed outside the enclosure, making the installation thereof difficult and easy to induce problems of spring breaking and fatigue, eventually affecting the maintenance and the lifespan of the product. Further, the springs are respectively connected to the racks and due to the difference of the spring coefficients between the springs, or due to unbalanced operation of the media roll mounting mechanism that also leads to the difference in the spring coefficient between the springs, the tensions induced by the springs are different, and an unbalanced of spring force is caused where the restoration forces of the two media roll mounting mechanism are different. Consequently, the operation of installing or removing media roll may be subjected to undesired obstacles or the media roll cannot be securely held, eventually leading to deterioration of efficiency of operating the media roll and poor industrial value.

Other prior art references are also known, such as U.S. Pat. No. 7,131,178, which discloses a “direct thermal barcode printer”, wherein a construction similar to the previously discussed known techniques is provided. For example, in FIGS. 3 and 6 of the said US patent, each of a plurality of springs is coupled to a respective rack to provide a restoration force for a media roll mounting mechanism for realizing releasing or clamping of medial label roll by the medial roll mounting mechanism. Similar problems as that of the U.S. Pat. No. 5,813,343 occur in this US patent, namely installation difficult of the springs and easy to break or fatigue for the springs, and unbalanced restoration forces that leads to troubles and problems in releasing or clamping the medial roll.

### SUMMARY OF THE INVENTION

The medial roll mounting mechanisms of the conventional barcode printers as discussed above, face the problems of spring installation difficult and easy breaking and fatigue of the springs and unbalanced restoration forces caused by different spring coefficients that leads to troubles and problems in releasing and/or clamping a media roll.

Thus, the present invention aims to provide a label roll holder returning mechanism for a barcode printer, comprising at least one restoration roller, a coiled resilient element, at least two movable rails, and at least two label roll holding elements. The restoration roller is rotatably mounted to a bottom of the barcode printer and has a top portion forming a positive-movement engagement section. The coiled resilient element is received inside the restoration roller to provide a restoration force to the rotation of the restoration roller. The movable rails are set to the bottom of the barcode printer in a substantially parallel manner. Each movable rail has a surface forming at least one counterpart positive-movement engagement section engaging the positive-movement engagement section of the restoration roller. The label roll holding elements are arranged at a top of the barcode printer and are coupled to the movable rails respectively, whereby the label roll holding elements offer the function of outward separating from each other for removing and installing a roll of label and inward approaching each other to clamp and hold the label roll by means of the engagement between the restoration roller and the movable rails and the restoration force thereof. As such, a label roll holder returning mechanism featuring balanced force restoration is provided.

The effectiveness of the label roll holder returning mechanism of the present invention is that a restoration roller that contains therein a coiled resilient element is used to drive outward separation or inward approaching of label roll holding elements of a barcode printer, wherein no resilient element is exposed outside the barcode printer to thereby effectively the risk of failure and breaking of the resilient element and that of fatigue of the resilient element. Further, the restoration roller imposes direct and balanced driving of two movable rails that in turn drive the label roll holding elements so as to make the operation of the label roll holder returning mechanism more smooth to ensure secure clamping of a label roll and remarkably increase the industrial value of the present invention.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a label roll holder returning mechanism constructed in accordance with a first embodiment of the present invention for a barcode printer;

FIG. 2 is another perspective view of the label roll holder returning mechanism in accordance with the present invention;

FIG. 3 is an exploded view of the label roll holder returning mechanism of the present invention, together with a chassis of the barcode printer to which the label roll holder returning mechanism is mounted;

FIG. 4 is a perspective view of a restoration roller and a coiled resilient element that constitute in part the label roll holder returning mechanism of the present invention;

FIG. 5 is an exploded view of FIG. 4;

FIG. 6 is an exploded view of the label roll holder returning mechanism of the present invention taken at a different perspective, together with the chassis of the barcode printer to which the label roll holder returning mechanism is mounted;

FIG. 7 is a perspective view illustrating label roll holding elements and movable rails of the label roll holder returning mechanism of the present invention;

FIG. 8 is a perspective view illustrating an application of the label roll holder returning mechanism of the present invention in a barcode printer;

FIG. 9 illustrates a condition where the label roll holding elements of the label roll holder returning mechanism of the present invention are inwardly moved to clamp on a roll of labels; and

FIG. 10 illustrates a second embodiment of the label roll holder returning mechanism of the present invention.

### DETAILED DESCRIPTION OF THE PREFERRED EMBODIMENTS

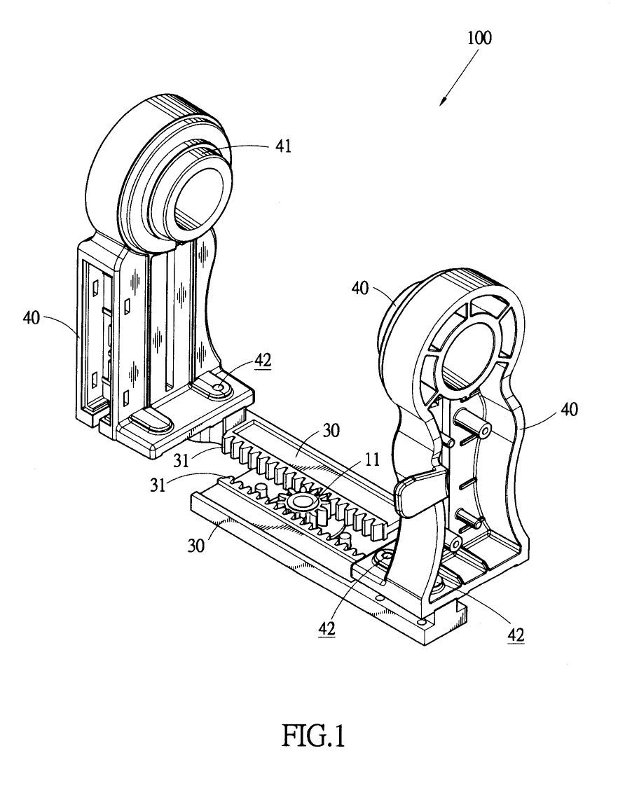

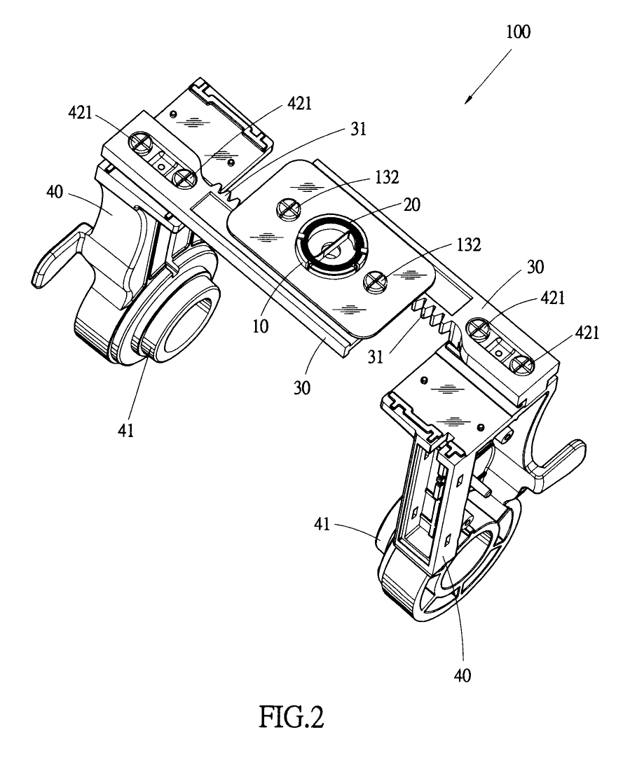

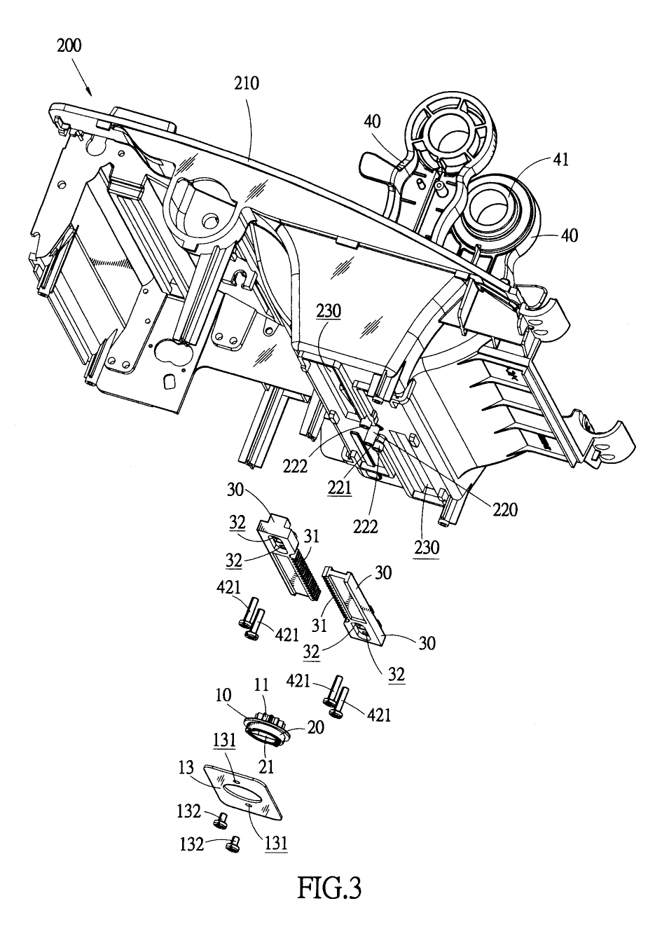

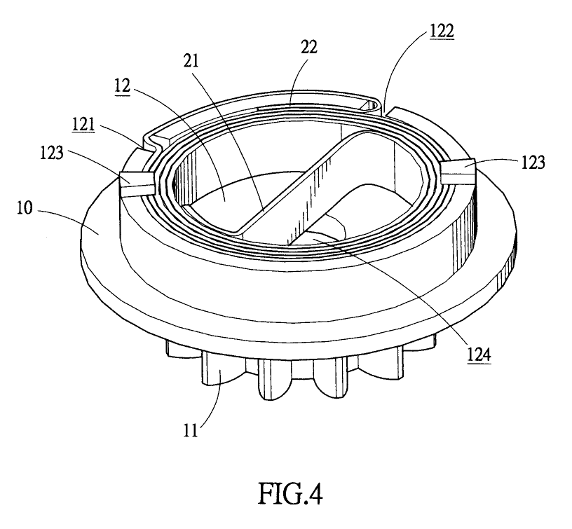

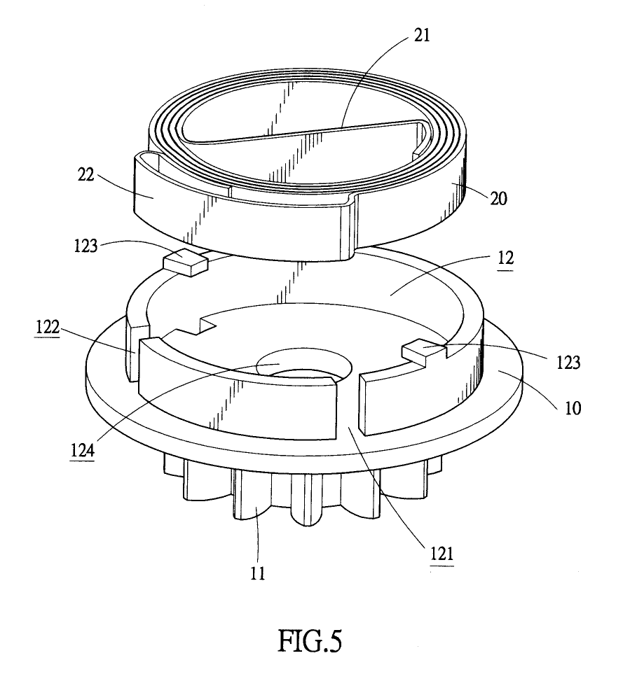

With reference to the drawings and in particular to FIGS. 1-5, a label roll holder returning mechanism constructed in accordance with the present invention, generally designated with reference numeral 100, is provided for a barcode printer 200. The label roll holder returning mechanism comprises at least one restoration roller 10 having a top portion forming at least one positive-movement engagement section 11, which can be an element or structure that ensures a positive movement, such as a pinion, or is, alternatively, an element or structure exhibiting high frictional engagement to ensure the positive movement, such as a rubber made element that has high frictional coefficient and may provide a high frictional force. Other equivalent constructions or elements are considered within the scope of the present invention. The restoration roller 10 has a lower portion forming at least one chamber 12. The chamber 12 is delimited by a circumferential wall (not labeled) in which two notches 121, 122 are defined and two retention tabs 123 are provide on a free edge of the wall and extending into the chamber 12. A bore 124 is defined centrally in the restoration roller 10 and is set to correspond to an axle 220 formed in a bottom of a chassis 210 of the barcode printer 200. A transverse slit 221 is defined through the axle 220. Further, two mounting holes 222 are defined in the bottom of the chassis 210 of the barcode printer 200 adjacent to the axle 220. A plate 13 forms a bore fit over the circumferential wall delimiting the chamber 12. The plate 13 also forms two through holes 131 respectively corresponding to the mounting holes 222 of the chassis 210 of the barcode printer 200 for receiving therethrough fasteners 132, such as bolts, to secure the plate 13 to the bottom of the chassis 210 in order to rotatably mount the restoration roller 10 to the bottom of the chassis 210.

At least one coiled resilient element 20, which in the embodiment illustrated, is a coil spring, is received in the chamber 12 formed in the lower portion of the restoration roller 10. The resilient element 20 has an inner end 21 that extends across the bore 124 of the restoration roller 10 and is fit into the transverse slit 221 of the axle 220 of the barcode printer 200 and an outer end 22 passes through the notch 121 and engages the notch 122 to impose a restoration force to cause the restoration roller 10 to rotate about the axle 220. The resilient element 20 is retained in side the chamber 12 by means of the retention tabs 123 of the chamber 12.

At least one movable rails 30 that are set in two slide slots 230 defined in the bottom of the chassis 210 of the barcode printer 200 in a movable manner and are substantially parallel to each other. Each of the movable rails 30 has a surface on which at least one positive-movement engagement section 31 is formed. The positive-movement engagement section 31 provide a structure that ensures a positive movement, such as a toothed rack that is taken as a preferred example in the present invention, or is, alternatively, an element or structure exhibiting high frictional engagement to ensure the positive movement. The positive-movement engagement sections 31 engage the positive-movement engagement section 11 of the restoration roller 10 whereby the movable rails 30 are acted upon by the restoration force of the restoration roller 10 to take linear reciprocal motion along the slide slots 230. Each of the movable rails 30 forms fixing holes 32 at an end thereof.

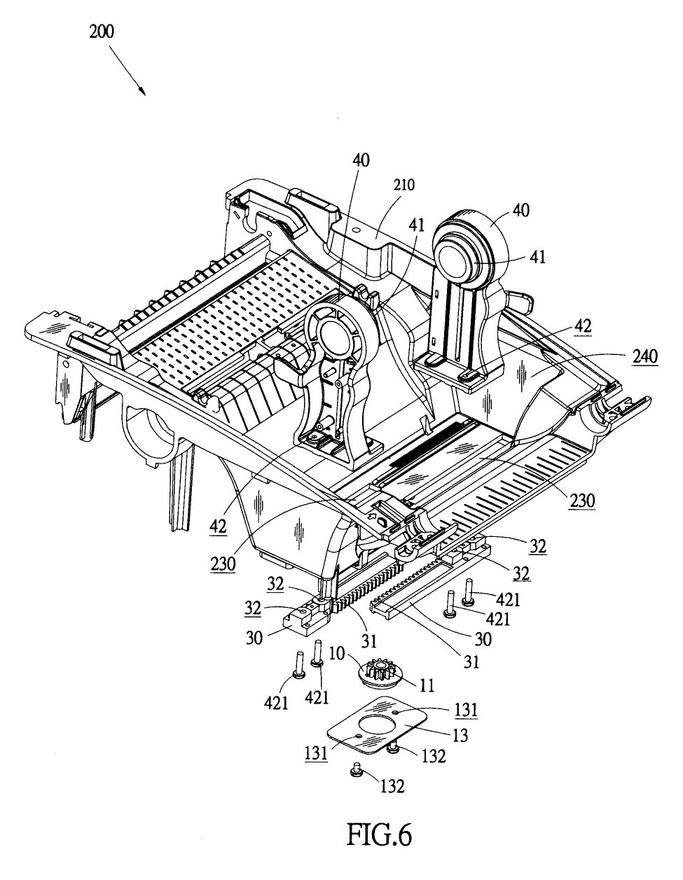

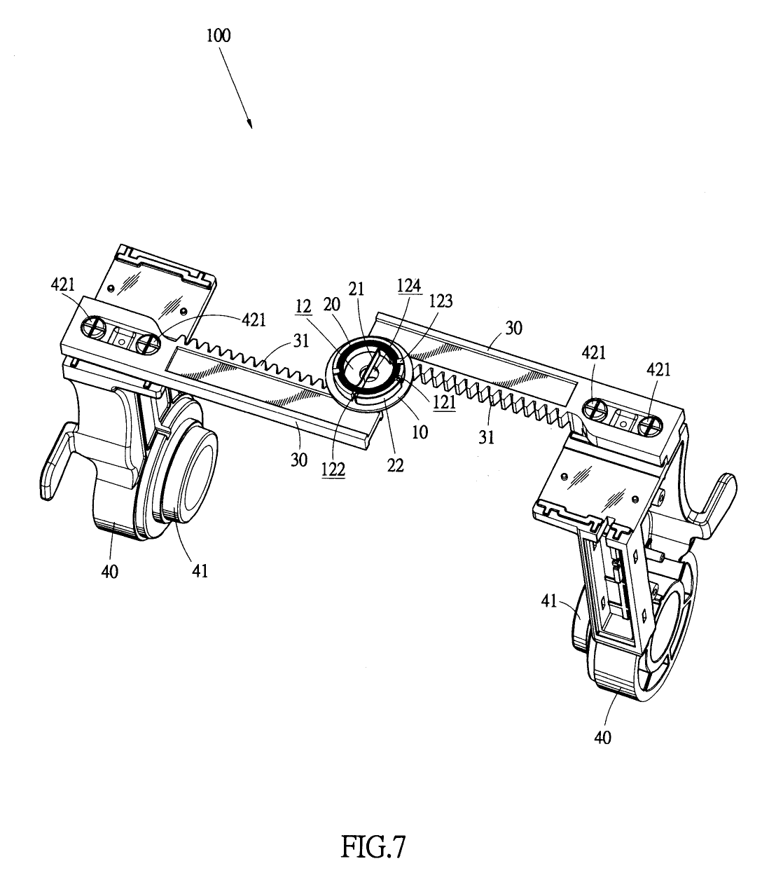

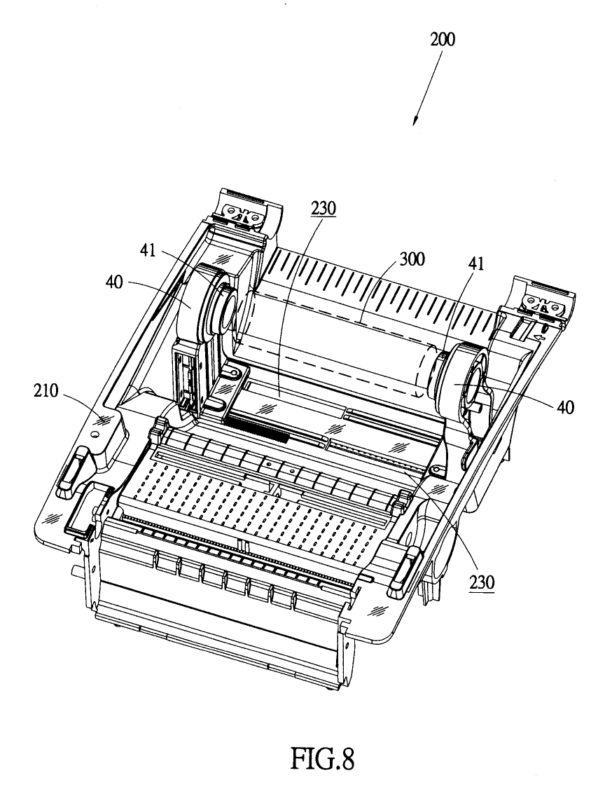

Also referring to FIGS. 6 and 7, at least a pair of label roll holding elements 40 is received in a label roller chamber 240 defined in the top of the chassis 210 of the barcode printer 200. Each label roll holding element 40 has a top end section forming in an inside face thereof a label roll clamping section 41, whereby a roll of label 300 (see FIG. 8) can be securely held by and between the label roll clamping sections 41. Each label roll holding element 40 has a lower end forming fixing holes 42 that respectively correspond to the fixing holes 32 of the respective movable rail 30 whereby fasteners 421, such as bolts, can be received through the fixing holes 32 to engage the fixing holes 42 so as to fix the label roll holding elements 40 to the movable rails 30 respectively, allowing the label roll holding elements 40 to drive the movable rails 30 for linear reciprocal motion.

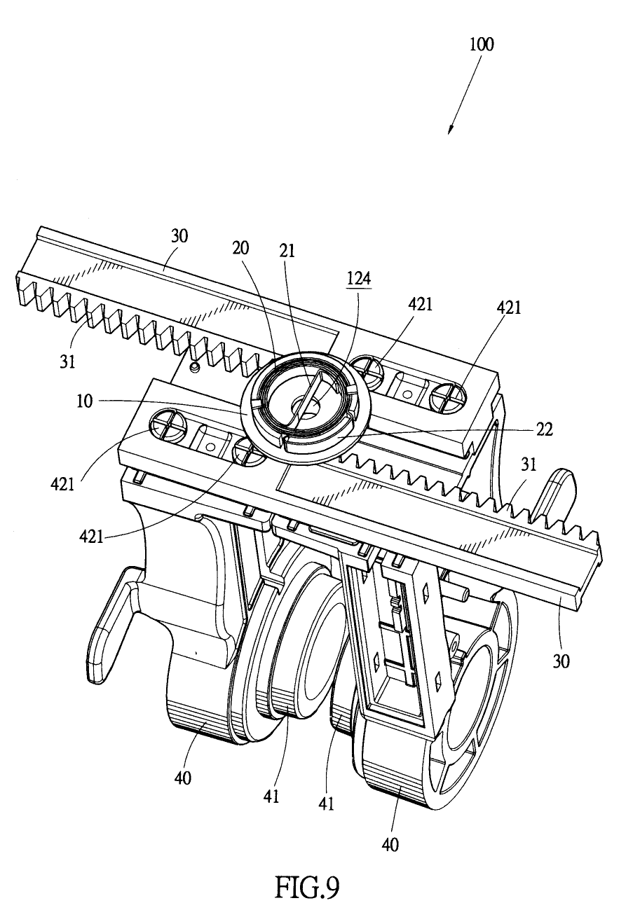

Also referring to FIGS. 8 and 9, an application of the label roll holder returning mechanism 100 in accordance with the present invention is demonstrated. By means of the transversely outward/inward movement of the label roll holding elements 40 inside the label roller chamber 240 defined in the top of the chassis 210 of the barcode printer 200, the movable rails 30 are caused to do linear motion in a separating manner (transversely outward) or approaching manner (transversely inward) and the resilient element 20 of the restoration roller 10 is caused to build up a restoration force or to release the restoration force. In this way, the label roll 300 can be removed and replaced or newly installed once the label roll holding elements 40 are transversely outward moved and separated; the label roll 300 can be securely held in position by being clamped by the label roll holding elements 40 that are transversely inward moved to approach each other.

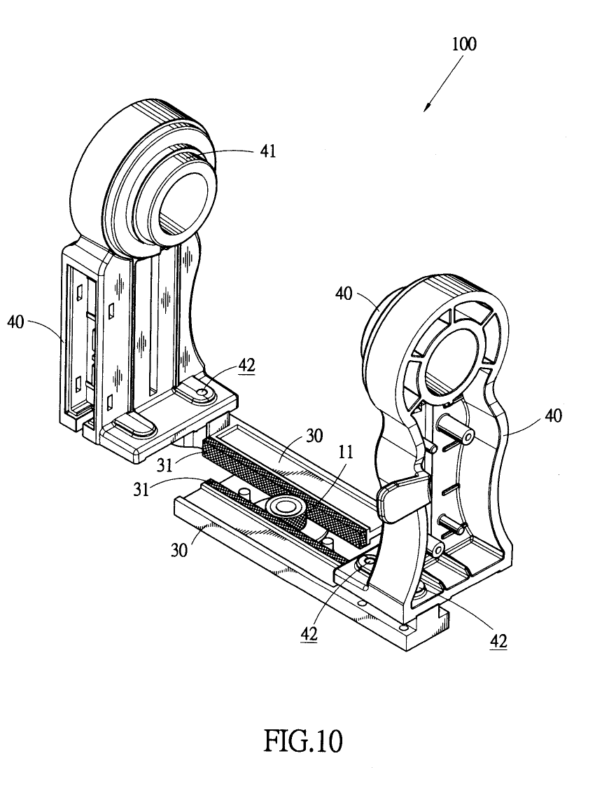

As shown in FIG. 10, a second embodiment of the label roll holder returning mechanism 100 in accordance with the present invention is shown. In the second embodiment, the positive-movement engagement section 11 formed in the top portion of the restoration roller 10 is replaced by a high-friction rubber roller and corresponding thereto, the positive-movement engagement section 31 of the movable rails 30 are made of high-friction rubber bars, whereby a driving coupling is established between the positive-movement engagement section 11 of the restoration roller 10 and the positive-movement engagement section 31 of the movable rails 30 by the high-friction engagement therebetween for building up and releasing the restoration force. Thus, the similar function with that demonstrated in FIGS. 8 and 9, where the label roll 300 can be replace or newly installed by separating the label roll holding elements 40 and the label roll 300 can be securely held in position by having the label roll holding elements 40 approaching each other to clamp the label roll 300, can also be realized.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A label roll holder returning mechanism for a barcode printer, comprising:
at least one restoration roller, which forms at least one positive-movement engagement section, the restoration roller being rotatably mounted to a bottom of a chassis of the barcode printer;
at least one coiled resilient element, which is received and retained inside a lower portion of the restoration roller and has an inner end coupled to the bottom of the chassis of the barcode printer and an outer end coupled to the restoration roller to provide the restoration roller with a restoration force for rotation thereof;
at least two movable rails, which are set in the bottom of the chassis of the barcode printer in a substantially parallel manner, the movable rails each forming a counterpart positive-movement engagement section corresponding to and engaging with the positive-movement engagement section of the restoration roller so that the restoration force of the restoration roller is allowed to act on the movable rails to induce linear and reciprocal motion of the movable rails;
at least two label roll holding elements, which are fixed at a top of the chassis of the barcode printer, the label roll holding elements forming label roll clamping sections to clamp a roll of label therebetween, the label roll holding elements being respectively attached to the movable rails so that the label roll holding elements are caused by the restoration force of the restoration roller to selectively move outward for separation from each other or move inward to approach each other by means of the linear motion of the movable rails.

2. The label roll holder returning mechanism as claimed in claim 1, wherein the positive-movement engagement section of the restoration roller comprises a pinion.

3. The label roll holder returning mechanism as claimed in claim 1, wherein the positive-movement engagement section of the restoration roller comprises a high-friction rubber roller.

4. The label roll holder returning mechanism as claimed in claim 1, wherein the lower portion of the restoration roller forms a chamber receiving the coiled resilient element therein.

5. The label roll holder returning mechanism as claimed in claim 4, wherein the chamber is delimited by a circumferential wall in which two notches are formed, and two retention tabs being provided on the wall.

6. The label roll holder returning mechanism as claimed in claim 4, wherein a plate forming a bore is fit over the chamber.

7. The label roll holder returning mechanism as claimed in claim 6, wherein the plate forms two through holes.

8. The label roll holder returning mechanism as claimed in claim 1, wherein the coiled resilient element comprises a coil spring.

9. The label roll holder returning mechanism as claimed in claim 1, wherein the counterpart positive-movement engagement section of the movable rail comprise a toothed rack.

10. The label roll holder returning mechanism as claimed in claim 1, wherein the counterpart positive-movement engagement section of the movable rails comprises a high-friction rubber bar.

11. The label roll holder returning mechanism as claimed in claim 1, wherein each movable rails has an end forming fixing holes.

12. The label roll holder returning mechanism as claimed in claim 11, wherein each label roll holding elements forms fixing holes corresponding to the fixing holes of the movable rail.
